(19) United States
(12) Patent Application Publication
(10) Pub. No.: US 2009/0218235 A1
(43) Pub. Date: Sep. 3, 2009

(54) Gas sensor

(76) Inventors: Robert C. McDonald, Stow, MA (US); Katherine E. Harrison, North Cambridge, MA (US); Min Chen, Naperville, IL (US)

Correspondence Address: KRIEGSMAN & KRIEGSMAN, 30 TURNPIKE ROAD, SUITE 9, SOUTHBOROUGH, MA, 01772, US

(21) Appl. No.: 12/317,935

(22) Filed: Dec. 29, 2008

Related U.S. Application Data
(60) Provisional application No. 61/009,275, filed on Dec. 26, 2007.

(51) Int. Cl. G01N 27/26

(52) U.S. Cl. 205/775; 204/431

(57) ABSTRACT

Metal-oxide gas sensor. According to one embodiment, the sensor includes a layer or pellet of tungsten trioxide (WO₃) substituted with one or more added metals. Preferably, the added metals are substituted in a concentration between about 0.005 and 10%, have an oxidation state less than +6, and possess a similar ionic radius to W⁶⁺. The substituted metal oxides are preferably formed as nanoparticles and sintered into a dense structure or coating possessing a surface-depletion layer sensitive to the surface adsorption of gas molecules and whose resistance changes in a predictable manner with gas adsorption. The extent of resistance change, rate of change and rate of desorption can be different for different gases, depending on the gas molecule's polarizability, dipole moments and electron configuration. The sensor can be used in a wide range of temperatures and corrosive conditions because of the intrinsic stability of the substituted metal oxides.

### CROSS-REFERENCE TO RELATED APPLICATIONS

The present application claims the benefit under 35 U.S.C. 119(e) of U.S. Provisional Patent Application No. 61/009,275, filed Dec. 26, 2007, the disclosure of which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. OII-0539223 awarded by the National Science Foundation and Contract No. FA8650-04-M-2440 awarded by the United States Air Force.

### BACKGROUND OF THE INVENTION

The present invention relates generally to gas sensors and relates more particularly to metal-oxide gas sensors.

There are many situations in which it is desirable to detect the presence of or the concentration of a specific gas in a sample. Gas sensors used for such purposes come in a variety of different forms and include metal-oxide sensors, spectroscopic sensors, electrochemical sensors, and catalytic sensors. Metal-oxide sensors provide a number of important advantages over spectroscopic, electrochemical, and catalytic sensors, such as low cost, simplicity of electronic design, ruggedness, and durability. These advantages have led to metal-oxide sensors being used, for example, in diesel and gasoline automotive-emission-control systems.

The way in which metal-oxide sensors typically function is that gas molecules of interest adsorb onto the sensor, such adsorbed molecules either enriching or depleting the oxide surface of electrons or holes, depending on the specific interaction. By measuring changes in oxide-sensor conductivity and calibrating with known gas compositions, the extent of gas adsorption and concentration can be determined. For example, in the case of Lewis bases like sulfides interacting with SnO₂, a surface-depletion layer is created with elevated conductivity. The depth of the surface-depletion layer, L_{D}, of metal oxides can be expressed as:

L_{D}=(∈₀KT/n₀e²)^{1/2}

where ∈₀ represents the static dielectric of the oxide, K represents Boltzman's constant, nₒ represents e total carrier concentration, and e represents carrier charge.

For metal-oxide sensors, the highest sensitivity is obtained when the surface-conduction layer thickness, L_{D}, is half the diameter of oxide particles or half the thickness of a film. In this case, the relative volume of oxide, which is sensitive to changes in the gas composition, is maximized. The sensitivity, S, of metal-oxide sensors is measured in terms of the change in conductivity, G, resulting from an increase in the number of charge carriers:

S=ΔG/Gₒ=(Δn/nₒ)L_{D}

For example, in the case of H₂ and CO absorption on stannic oxide, significant improvements in sensitivity can be achieved when the particle size can be reduced below 20 nanometers. Sensitivity here is defined as

Sensitivity=(R_{g}−Rₒ)/R₀

where R_{g} and Rₒ are the sensor resistance readings after and before gas adsorption.

The adsorption can be assisted by exposing the oxide to radiation with energies slightly exceeding the oxide-band-gap energy (photo-assisted adsorption-desorption). If adsorption is accompanied by bond breaking or new bond formation, chemisorption has occurred. If not, the process is termed physical adsorption. In either case, the surface electronic orbital in the oxide is altered to produce a region of elevated electronic conductivity.

Conventional metal-oxide sensors require the presence of excess oxygen, which reacts with the target gas (analyte) at the sensor surface. These sensors consist of a metal-oxide semiconductor like SnO₂ or TiO₂, which is bonded into a structure or coating and fitted with gold electrodes to measure resistance. Oxygen from the air adsorbs onto the surface of the sensor, depleting the surface slightly of electrons,

O₂+2e→2O_{ads}

and thus changing the electronic conductivity at the surface. This type of sensor takes advantage of oxygen mobility in the so-called surface-depletion layer (SDL), which lies within about 50-100 nm of the oxide surface. A disadvantage of this type of gas sensor is that oxygen is required to support the reaction at the sensor surface. Thus, this type of gas sensor cannot be used to detect contaminants in gaseous mixtures which lack sufficient oxygen. Furthermore, oxides like tin oxide and titanium oxide can be reduced at elevated temperatures when oxygen is absent and also when in the presence of reducing gases. Thus, many commercially available metal-oxide sensors have limited service life under rugged conditions and at elevated temperatures.

Other documents of interest include the following, all of which are incorporated herein by reference: U.S. Pat. No. 3,644,795, inventor Taguchi, issued Feb. 22, 1972; Azad et al., J. Electrochem. Soc., 139, 3690 (1992); Bender et al., Sensors and Actuators, B77, 281 (2001); Butler et al., J. Electrochem. Soc., 125, 228 (1978); Cosandey et al., JOM-e, 52, 10 (2000); de Lacy Costello et al., Sensors and Actuators B, 92, 159 (2003); Liu et al., Abstracts of the 225^{th} ACS National Meeting, New Orleans, La., Mar. 23-27, 2003; Ma et al., Catalysts Today, 77, 107 (2002); Padley et al., J. Catalysis, 148, 438 (1994); Tarbuck et al., J. Phys. Chem. B, 102, 7845 (1998); Yu et al., Appl. Catalysis A: General, 242, 111 (2003); and Zhdanova et al., Kinetics and Catalysis, 41, 812 (2000).

### SUMMARY OF THE INVENTION

It is an object of the present invention to provide a novel gas sensor.

It is another object of the present invention to provide a gas sensor that addresses at least some of the disadvantages associated with conventional gas sensors.

Therefore, according to one aspect of the invention, there is provided a gas sensor comprising a metal-substituted tungsten (VI) oxide and means for measuring changes in electronic properties of the metal-substituted tungsten (VI) oxide that are induced by adsorption of a target gas thereon. Preferably, the added metals are substituted in a concentration between about 0.005 and 10%, have an oxidation state less than +6, and possess a similar ionic radius to W⁶⁺.

The present invention is also directed at a gas sensor array comprising a plurality of gas sensors, wherein two or more of the gas sensors are identical or different.

The present invention is also directed at methods of using the above-described gas sensor and gas sensor array.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a graph depicting the results of Example 1 (with two adjacent sensors being shown together);

FIG. 2 is a graph depicting the results of Example 2;

FIG. 3 is a graph depicting the results of Example 3;

FIG. 4 is a graph depicting the results of Example 4;

FIG. 5 is a graph depicting the results of Example 5;

FIG. 6 is a graph depicting the results of Example 8;

FIG. 7 is a graph depicting the results of Example 9;

FIG. 8 is a graph depicting the results of Example 10; and

FIG. 9 is a graph depicting the results of Example 11.

### DETAILED DESCRIPTION OF PREFERRED EMBODIMENTS

The present invention is directed at a gas sensor that includes a metal-substituted tungsten (VI) oxide (WO₃) structure. The substitution with metal cations having an ionic radius close to that of tungsten (VI) in WO₃ (0.62 angstrom) creates changes in the electronic and atomic structure of the material, as well as the concentration of mobile charge carriers and the mobility of these carriers, while leaving the crystal structure intact, provided that doping is limited to less than about 10% by weight.

Accordingly, the substituting metals are preferably substituted in a concentration between about 0.005 and 10% by weight, more preferably about 0.1 to 2% by weight. In addition, the substituting metals preferably have an oxidation state less than +6 and more preferably have a highest oxidation state of +2, +3, +4 or +5. Additionally, the substituting metals preferably possess an ionic radius similar to W⁶⁺, preferably about 0.54 to 0.72 angstrom, more preferably about 0.61 to 0.66 angstrom. Examples of the substituting metals include, but are not limited to, Ni(II), Mg(II), Cu(II), Bi(III), Bi(V), Co(III), Ir(IV), Ru(IV), Sn(IV), Ti(IV), Nb(V), and Ta(V). (The above list of substituting metals is not exhaustive, and more expensive metals, such as platinum or palladium, may also be used.)

Plasma-deposition methods may be used, for example, to prepare doped tungsten-oxide powders of small particle size, i.e., less than 1 micrometer in diameter, preferably 0.010 to 0.100 micrometers in diameter. These powders may then be pre-pressed and sintered into a dense structure or coating for use as a sensor. Without being limited to any particular dimensions for the sensor, the thickness of the sensor may be, for example, from about 0.5 mm to about 1 mm, and the diameter of the sensor may be, for example, about 5 mm.

A suitable electronic connection (e.g., gold cermet or metal epoxy) may be made to the sensor for measurement of its resistance. The material of the electronic connection may be chosen based on the measurement temperature and potential interfering effects of the gases/vapors to be measured. Measurement can be made directly with an AC bridge meter or with an electronic applied voltage and operational amplifier (op-amp) measuring circuits with an applied voltage, for example, of about 1-1000 mV. A ceramic mounting plate may be used to hold a pair of metal-oxide sensors mounted in a MACOR® ceramic plate (Corning, Inc.).

The sensor may further include a housing comprising a stainless steel cylindrical member with one end welded shut. At the other end may be a removable end plate attached with a sanitary fitting and graphite gasket to exclude air and to prevent the escape of vapors to be measured. Two pipes may be attached, one for the inlet of gases to be measured and one for the outlet. In a preferred embodiment of the sensor, the outlet permits free escape of gases to application to prevent build-up or variation of pressure in the housing. In addition, CONAX® fittings may be included in the removable bulkhead to admit wiring for sensing electronics and a hermetic feedthrough for thermocouple wiring. The wiring may permit independent measurement of each of two sensor's resistance, application of an electrical bias between sensors and measurement of sensor plate temperature. The temperature of incoming vapors may be measured by a thermocouple near the entry port. The temperature values may be used in processing the output readings to correct for temperature effects. In one variant of the housing, the sensor plate may be rigidly attached to the exit tube for support.

It may be noted that the sensor resistive response may be either increasing or decreasing. The magnitude and direction of this response may depend on gas flow rate, temperature, the relative reducing/oxidizing power of the analyte gas, and the oxide dopant metal. These variables can be optimized and/or calibrated for a particular application.

AC impedance measurements on different doped tungsten-oxide materials as a function of temperature showed a characteristic minimum in resistance at 200-400° C., characteristic of semiconductor oxides. This is believed to result from the creation of charge carriers with temperature, followed by a metal-like loss in conductivity as electron-lattice scattering increases with temperature. Thus, the temperature for optimal sensor conductivity can be engineered with proper choice of dopant.

Ultraviolet/visible reflectance spectroscopy was used to examine the absorbance spectra of WO₃ doped with 1% Sn(IV) and 1% Ti(IV). The resultant spectra showed a shift in the bandgap from that of undoped WO₃. This result suggests that the electronically active surface-depletion layer of these doped oxides could be tailored to interact with adsorbed gas molecules such that a rapid, quantitative change in measured resistance could be used to detect trace gases whose dipole moment and electronic polarizability were sufficiently different from the matrix (bulk) gas.

Tungsten oxide doped with metal ions of similar ionic radii is favorable for the present invention because of its chemical stability and ability to sense certain gases in anaerobic conditions. These materials ensure low material costs for the device. Tungsten oxide is the most acidic of any oxide yet characterized. Tungsten oxide has a very high electronegativity of 6.53 and a very low pH_{pzc} (pH of 0.43). Tungsten oxide has a bandgap of 2.7 eV, which the present inventors have been able to adjust using admixed metal ions at less than 10% levels. These chemical properties of solid oxides help determine which gases adsorb, the rate of absorption/desorption, and the change in electronic conductivity at the surface. The different mixed-oxide variants of tungsten oxide have somewhat different surface adsorption coefficients for different Lewis Base gases, such as dibenzothiophene (DBT), a frequent contaminant in liquid hydrocarbon fuels. The surface charge on tungsten oxide is sufficiently strong so that non-polar molecules like Cl₂ have been successfully detected at sub-ppm levels. This is true because the molecules are large and polarizable. The present inventors reason that, by doping the tungsten-oxide structure to modify the electronic structure at the surface, different gases can be detected, measured, and differentiated based on differences in their molecular polarizability, dipole moment and electronegativity.

Traces of organosulfur vapors are known to adsorb onto oxide surfaces. Thiophene and its derivatives are known to adsorb onto metal oxides, especially acidic oxides. The interactions have been studied by synchrotron-based photoemission with TiO₂, infrared spectroscopy on γ-Al₂O₃ and Cu/Al₂O₃, and in hydrosulfurization reactions of thiophene on ZSM5 zeolites. There is evidence that the sulfur of thiophene bonds to the surface of TiO₂ through its unbonded electron pair.

By using a plurality of the above-described gas sensors, each designed for a specific contaminant, it may be possible to discriminate mixtures of contaminants in a gas sample.

One advantage of the above-described doped tungsten (VI) oxide gas sensor is that the loss of oxygen at elevated temperatures is minimized. This is because oxygen vacancies are controlled at a constant level by doping with metals in their highest oxidation state. As a result, unlike conventional sensors, the present sensor is capable of functioning in the absence of air or oxygen and is capable of being used in either an oxidizing environment, such as air, or a reducing environment, such as hydrocarbon vapors.

In addition, adsorption onto the gas sensor may also be controlled by using a pair of sensors mounted in a ceramic insulator substrate, placing a potential on each sensor, and periodically reversing the applied electric field to alternate the adsorption and desorption on each sensor head.

The examples below are illustrative only and do not limit the present invention. In these examples, the sensor is disclosed being used in a flowing gas stream; however, it should be understood that the same sensor could be used in a slip stream where a portion of the gas flows through a parallel pathway. Also, although the sensors below possess two sensor elements, it is to be understood that the present invention encompasses multiple sensor elements with differing sensitivities for different gases or vapors.

### Example 1

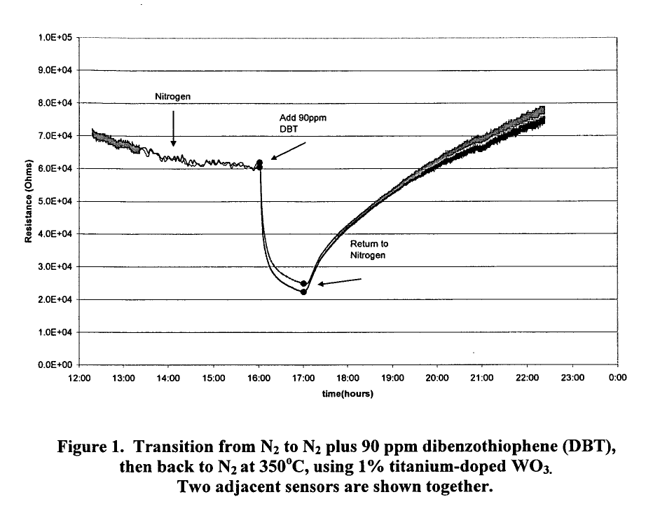

A nanopowder of 1% Ti-doped WO₃ was prepared by plasma vapor deposition. The powder was pre-compressed into circular pellets each with a diameter of 5 mm and a thickness of 1 mm. Two of these pellets were placed into 1-mm-deep wells in a ceramic plate (MACOR® from Corning, Inc.). A sensor was constructed by placing a pair of electrodes at either end of the pellets using gold cermet (electronically conductive gold/ceramic composite) placed on the surface of the ceramic plate and contacting the pellet. Stainless steel fittings were used to bind high-temperature insulated wiring to the cermet electrodes for connection to an ohmmeter. The sensor plate was placed in a stainless steel housing equipped with sealed feedthroughs for sensing wires and thermocouples to measure the plate temperature. Also included were a pair of stainless steel tubes for inlet and outlet of vapor to be analyzed. This housing was placed in an oven. Following two hours of flushing with dry nitrogen gas, the oven was heated to 350° C. A vapor of dibenzothiophene (DBT) was prepared in a separate treatment oven, heated and mixed with dry nitrogen to produce 90 ppm DBT, then passed through the sensor housing, using nitrogen as a carrier gas. FIG. 1 shows the sensor response in the form of a rapid change in resistance. Both the rate of change (dR/dT) and the final resistance values of the two sensors were found to be proportional to the analyte gas concentration. The sensor response was reversible when purged with dry nitrogen. Thus, DBT, a reducing gas and common catalyst poison in fuel cells operating on reformed aviation fuels, was detectable in nitrogen in the absence of oxygen.

### Example 2

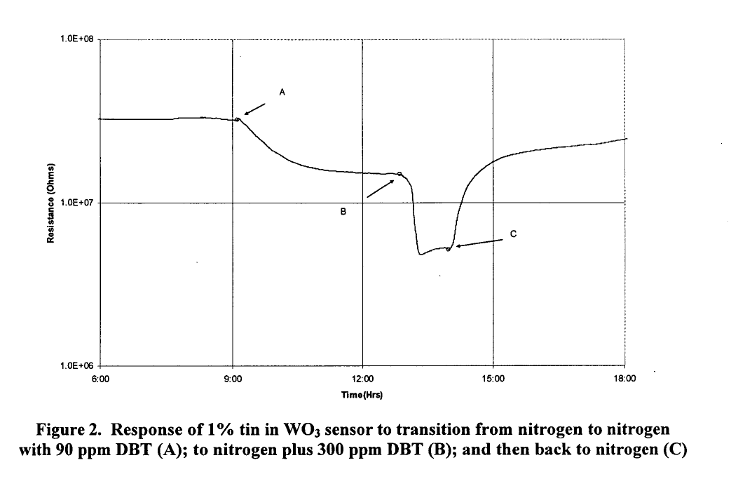

A gas sensor was prepared as in Example 1 and exposed to DBT vapors with a nitrogen gas carrier at 90 ppm and 300 ppm levels. The sensor responded at 350° C., a temperature of interest for fuel desulfurization systems, with both the rate of resistance change and the absolute change in proportion to the DBT content as seen in FIG. 2.

### Example 3

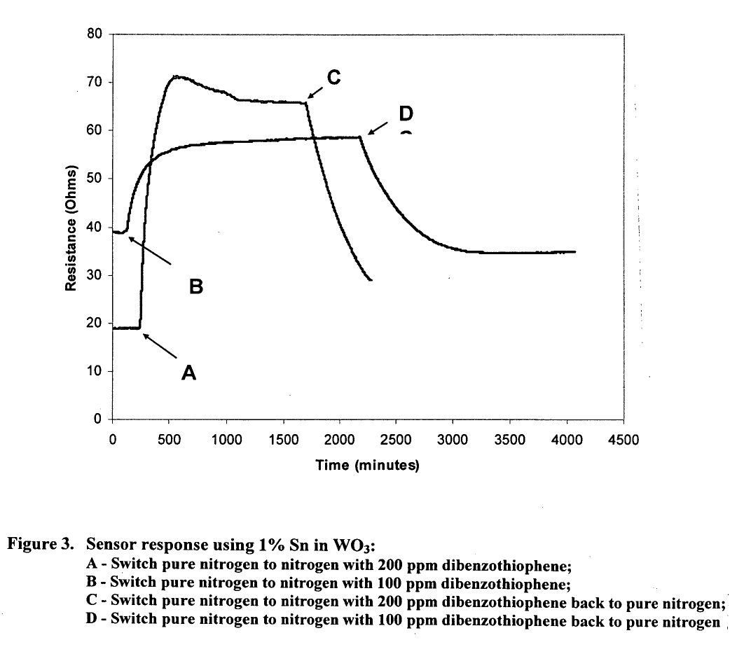

A gas sensor was prepared as in Example 1 and exposed to nitrogen followed by (A) nitrogen with 200 ppm dibenzothiophene and then (C) back to nitrogen. In a separate measurement, the sensor was flushed with nitrogen followed by (B) nitrogen with 100 ppm dibenzothiophene and then (D) back to pure nitrogen. The two events are plotted together in FIG. 3 to show the relative changes in sensor resistance.

### Example 4

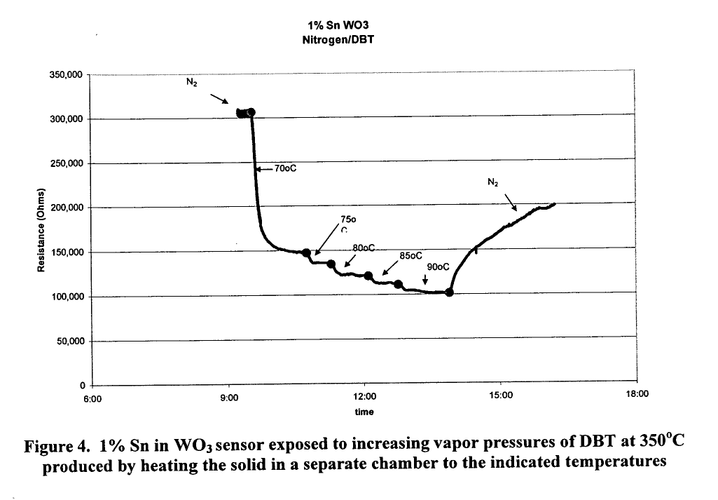

A gas sensor was prepared as in Example 1, except that 1% Sn was used as the doping metal in WO₃, instead of Ti. The sensor was purged with nitrogen as a starting point and exposed to increasing levels of DBT in a nitrogen carrier at 350° C. The trace sulfur-containing gas vapor was produced by sequentially heating the solid in a separate chamber, using dry nitrogen as a carrier gas. FIG. 4 illustrates the sensor response in the form of decreasing oxide resistance responding quickly to increasing vapor pressure of DBT.

### Example 5

A dual sensor was prepared using 1% Sn in WO₃, which was exposed to varying levels of DBT produced as in Example 1. The sensor response at 350° C. is summarized in the table below in terms of relative and absolute changes in resistance compared to pure nitrogen.

| ~ppm DBT | ΔR (Ω) | ΔR/Ro | ΔR/Δt (Ω/s) | Fractional Drop/s |
|---|---|---|---|---|
| 45 | 1.3 × 10⁷ | 0.48 | −4400 | −0.01% |
| 90 | 1.4 × 10⁷ | 0.63 | −14000 | −0.06% |
| 175 | 1.5 × 10⁷ | 0.77 | −17000 | −0.09% |
| 325 | 1.2 × 10⁷ | 0.78 | −25000 | −0.17% |

### Example 6

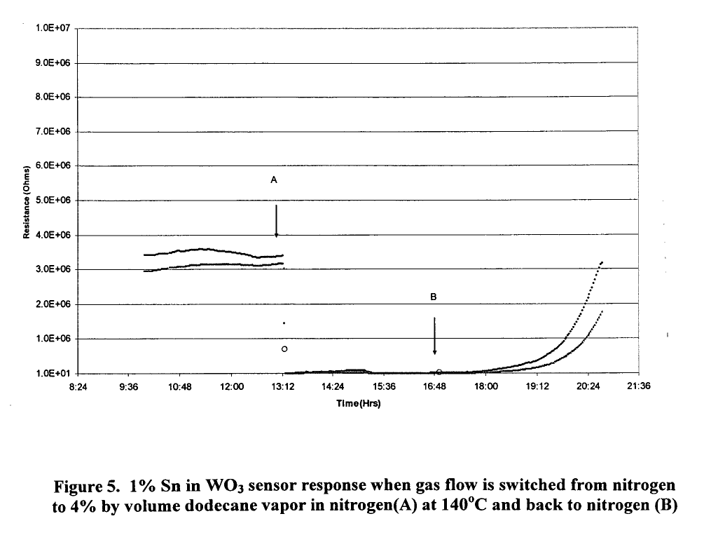

A dual sensor using 1% Sn in WO₃ was exposed first to dry nitrogen, then to 4% dodecane (C₁₂H₁₄) vapor. The vapor was produced by heating dodecane in a separate chamber and flushing this to the sensor housing with dry nitrogen. The measurements were conducted at 140° C. FIG. 5 illustrates the response curves.

### Example 7

Additional dodecane testing was carried out with a longer time allowed for steady state to be achieved after each change. 100-150 ppm DBT were added to a stream of 2500 ppm dodecane using a nitrogen carrier gas. The addition of 150 ppm DBT to the 2500 ppm dodecane stream dropped the resistance an additional 85%, to 0.1% of the nitrogen value. Thus, as shown in the table below, the DBT competes successfully with the alkane for adsorption sides on the oxide surface.

| | Original | After Dodecane |
|---|---|---|
| DBT (ppm) | 100 | 150 |
| R₀ (MΩ) | 0.20 | 26 |
| ΔR/R₀ | 0.75 | 0.58 |
| dR/dt (Ω/s) | −1100 | −23000 |
| Fractional Drop/s | −0.55% | −0.09% |
| Half Recovery Time (h) | 1.3 | 3.1 |

### Example 8

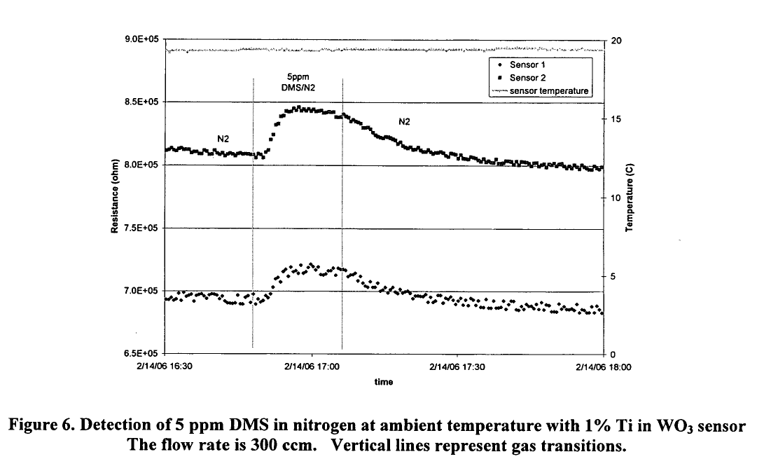

A dual sensor was prepared as above using 1% Ti in WO₃ as the sensing oxide. Nitrogen containing 5 ppm dimethyl sulfide (DMS), a reducing gas, was fed to the sensor housing at 40 cubic centimeters per minute (ccm) and at 20° C. The DMS caused a positive response in sensor resistivity within the 5- to 10-minute purge time as shown in FIG. 6. A nitrogen purge was used to remove the analyte gas for the next measurement. The two sensors are charted together to show consistency of response and oxide fabrication. The two readings can be used to improve sensor accuracy and signal response by averaging or other appropriate combination of the two outputs.

### Example 9

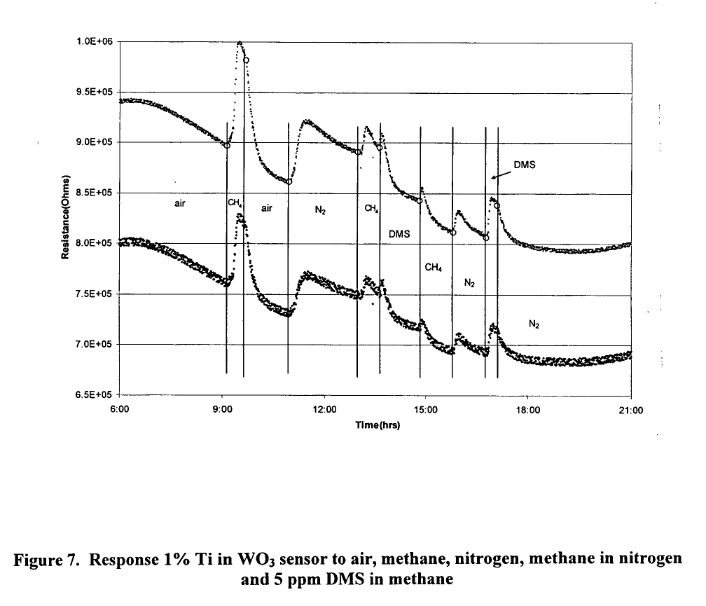

The 1% Ti in WO₃ sensor as in Example 8 was exposed to a series of gases and gas mixtures differing in their reducing properties, electronic structures and polarizabilities. The sensor was equilibrated with air or nitrogen, then exposed to pure methane, then to trace dimethyl sulfide in methane, followed by pure methane and finally a nitrogen purge gas. As shown in FIG. 7, it was characteristic of these doped tungsten oxides that reducing gases responded by decreasing resistance while the opposite was true with the addition of a more oxidizing gas.

### Example 10

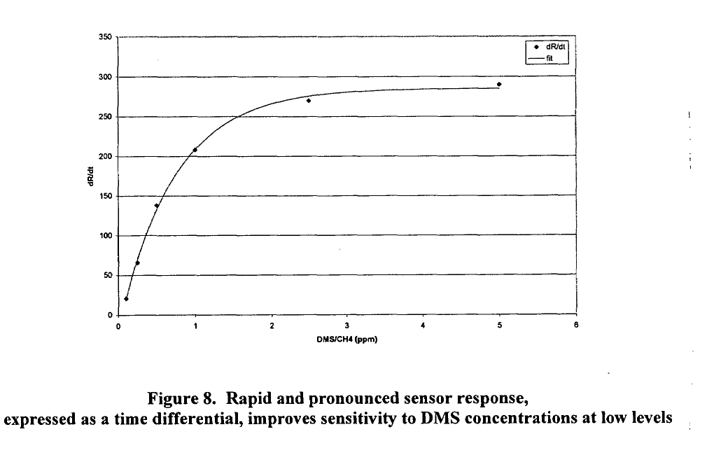

A 1% Ti in WO₃ sensor similar to Example 9 was exposed to a sequence of increasing levels of DMS in methane to simulate a measuring condition similar to that which might be useful in monitoring sulfur content in natural gas for fuel cell or synfuel applications. As seen in FIG. 8, the transition from methane to methane containing a small amount of gas with less reducing or more oxidizing character, such as DMS, caused a positive transient reading in the measured resistance. This transient is thought to be related to a temporary drop in carriers in the oxide SDL. The increase in sensor reading was proportional to the DMS content in methane. FIG. 8 shows the relationship between the time differential of this response and the actual value of the trace DMS gas.

### Example 11

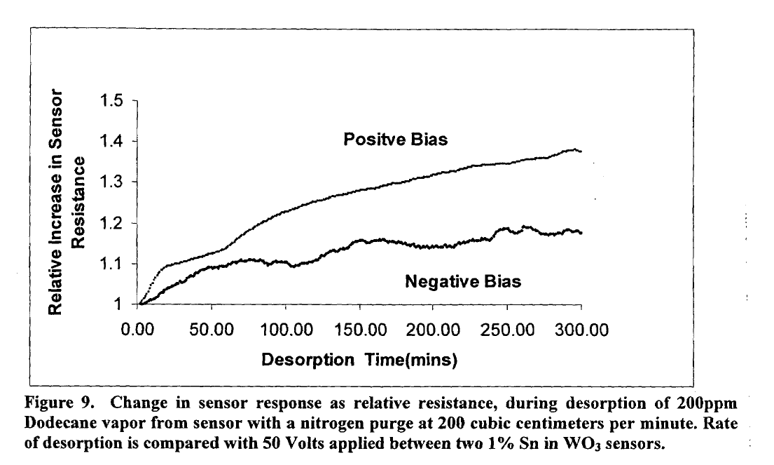

A dual sensor was prepared as described in Examples 1 and 5 using two sintered pellets prepared from a nanopowder of 1% Sn in WO₃. The dual sensor was first exposed to dodecane vapor, produced in a nitrogen bubbler, to obtain a constant sensor response. The sensor was then flushed with dry nitrogen gas at 200 cubic centimeters per minute (ccm) to remove the dodecane vapor from the sensor. A 50 Volt bias between the two sensors was applied. FIG. 9 shows the sensor responses, as a relative increase in resistance from the onset of dodecane desorption. The figure illustrates the effective control of desorption rate as governed by the sign of the voltage bias. This voltage control can be used to enhance sensor refresh rate and also to increase sensor response time.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A gas sensor comprising a metal-substituted tungsten (VI) oxide and means for measuring changes in electronic properties of the metal-substituted tungsten (VI) oxide that are induced by adsorption of a target gas thereon.

2. The gas sensor as claimed in claim 1 wherein the metal-substituted tungsten (VI) oxide is substituted with at least one metal in a concentration between about 0.005 and 10% by weight.

3. The gas sensor as claimed in claim 2 wherein the metal-substituted tungsten (VI) oxide is substituted with at least one metal in a concentration between about 0.1 to 2% by weight.

4. The gas sensor as claimed in claim 1 wherein the metal-substituted tungsten (VI) oxide is substituted with at least one metal having an oxidation state less than +6.

5. The gas sensor as claimed in claim 1 wherein the metal-substituted tungsten (VI) oxide is substituted with at least one metal having a highest oxidation state selected from the group consisting of +2, +3, +4 and +5.

6. The gas sensor as claimed in claim 1 wherein the metal-substituted tungsten (VI) oxide is substituted with at least one metal having an ionic radius similar to that of W⁶⁺.

7. The gas sensor as claimed in claim 1 wherein the metal-substituted tungsten (VI) oxide is substituted with at least one metal having an ionic radius of about 0.54 to 0.72 angstrom.

8. The gas sensor as claimed in claim 1 wherein the metal-substituted tungsten (VI) oxide is substituted with at least one metal having an ionic radius of about 0.61 to 0.66 angstrom.

9. The gas sensor as claimed in claim 1 wherein the metal-substituted tungsten (VI) oxide is substituted with at least one metal selected from the group consisting of Ni(II), Mg(II), Cu(II), Bi(III), Bi(V), Co(III), Ir(IV), Ru(IV), Sn(IV), Ti(IV), Nb(V), and Ta(V).

10. The gas sensor as claimed in claim 1 wherein the measuring means comprises means for measuring changes in resistance of the metal-substituted tungsten (VI) oxide that are induced by adsorption of a target gas thereon.

11. The gas sensor as claimed in claim 1 wherein the measuring means comprises means for measuring capacitance of the metal-substituted tungsten (VI) oxide that are induced by adsorption of a target gas thereon.

12. The gas sensor as claimed in claim 1 wherein the metal-substituted tungsten (VI) oxide comprises at least two surfaces with different electronic properties to a target gas adsorbed thereon.

13. The gas sensor as claimed in claim 1 wherein the metal-substituted tungsten (VI) oxide is prepared from particles smaller in size than 1 micrometer in diameter.

14. The gas sensor as claimed in claim 1 wherein the metal-substituted tungsten (VI) oxide is prepared from particles about 0.010 to 0.100 micrometers in diameter.

15. The gas sensor as claimed in claim 14 wherein the particles are cold-pressed and sintered to form a dense pellet or a thin coating applied to an insulating surface.

16. The gas sensor as claimed in claim 1 further comprising an insulating support, the metal-substituted tungsten (VI) oxide being supported on the insulating support.

17. The gas sensor as claimed in claim 1 wherein said measuring means comprises electrical connections, said electrical connections being selected from the group consisting of gold cermet or metal epoxy.

18. The gas sensor as claimed in claim 12 wherein the two surfaces are electronically biased relative to one another using an alternating potential applied to the two surfaces to control adsorption and desorption of a gas or gases of interest.

19. The gas sensor as claimed in claim 19 wherein a heating element is coupled to each of the two surfaces to at least one of control temperature and enhance the adsorption and desorption effects of the alternating potential.

20. A gas sensor array comprising a first metal-substituted tungsten (VI) oxide, a second metal-substituted tungsten (VI) oxide, and means for measuring changes in electronic properties of the first and second metal-substituted tungsten (VI) oxides that are induced by adsorption of a target gas thereon.

21. The gas sensor array as claimed in claim 20 wherein said first metal-substituted tungsten (VI) oxide and said second metal-substituted tungsten (VI) oxide are substituted with metals having different sensitivities to a target gas.

22. A method of detecting the concentration of a target gas comprising the steps of:
(a) providing the gas sensor of claim 1;
(b) exposing the gas sensor to the target gas;
(c) measuring a change in the electronic properties of the metal-substituted tungsten (VI) oxide that are induced by adsorption of the target gas thereon; and
(d) comparing the measured changes to appropriate standards to determine the concentration of the target gas.

23. The method as claimed in claim 23 wherein the concentration of the target gas is determined by a time differential of a transient reading.

24. The method as claimed in 22 wherein the target gas is present in a sample containing air or oxygen.

25. The method as claimed in claim 22 wherein the target gas is present in a sample containing no air or oxygen.
